(19) United States
(12) Patent Application Publication
(10) Pub. No.: US 2008/0060983 A1
(43) Pub. Date: Mar. 13, 2008

(54) Filter Element and Associated Data Transmission Device

(76) Inventor: Jorg Kleber, Neunkirchen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/664,834

(22) PCT Filed: Nov. 10, 2005
(86) PCT No.: PCT/EP05/12009

§ 371 Date: Apr. 6, 2007

(30) Foreign Application Priority Data
Nov. 10, 2004 (DE) 102004054172.8

(51) Int. Cl. B01D 27/00

(52) U.S. Cl. 210/85

(57) ABSTRACT

The invention relates to a filter element (1) for separating media, especially for filtering fluids such as hydraulic liquids. Said filter element can be received in a filter housing (2), with an inlet point (32) for the medium to be filtered and an outlet point (34) for the filtered medium. The invention is characterised in that at least one data memory (40, 42) forms part of the filter element (1), in such a way that the data stored in the data memory (40, 42) can be electronically read out of the data memory (40, 42) by means of a reading appliance (44, 46) arranged outside the filter element. The invention also relates to an associated data transmission device.

The invention relates to a filter element for separating media, in particular for filtering fluids, in particular, for example, hydraulic fluids, and an associated data transmission device.

For the filtration of liquid, gaseous or pasty media, for example beverages, hydraulic media or process fluids, filter elements that are matched to the respective application are used. These filter elements differ in numerous parameters, such as, for example, the material that is used for the filter material, its pore size or pressure stability. Visually, in many cases, these different features cannot be detected, or in any event cannot easily be detected. Therefore, in principle, the danger exists that in an existing filter device, a filter element that is not optimally suitable, or that is unsuitable for the respective application, is incorporated and thus both damage to the filter device and damage to the medium that is to be filtered can occur. Thus, for example, in the case of insufficiently fine filtration, wear or component failure of the filter device can occur; the equivalent applies when using filter elements with chemical and/or mechanical resistance that is inadequate relative to the medium to be filtered. In contrast, it can result in a contamination of the medium by release of harmful substances through the unsuitable filter element.

In addition, it is not ruled out that in an exchange of a used filter element, it is forgotten to use a new filter element in the corresponding filter housing, but rather that inadvertently the empty filter housing is connected to the filter device. In the closed state, this circumstance generally cannot be detected.

Another problem arises in that in a filter element that is in use, it cannot easily be determined how long the filter element still ensures adequate filtration in the given operating conditions. This applies all the more in certain filter element types that do not have any continuous reduction of the filtration property but rather in which the filtration property suddenly decreases after an operating period that depends on the respective type of operation.

From WO 00/32298 A, a fluid filter with a concealed machine-readable identification is known. The identification can have a read-only memory component (ROM), from which a so-called “silicon serial number” can be read.

From WO 01/044000 A, an RF transponder with a relaxation oscillator and a process for producing an oscillating measuring signal in an RF transponder are known.

The object of the invention is therefore to provide a filter element that overcomes the disadvantages of the prior art. In particular, the suitability of the filter element for the specified application can be reliably determined and monitored, preferably also automated and controlled by a control device. Consequently, the object of this invention is also to provide a corresponding data transmission device for equipping a filter device with a filter element according to the invention.

This object is achieved by the filter element that is specified in Claim 1 and by the data transmission device that is determined in the independent claim. Special designs of the invention are specified in the dependent claims.

The object is achieved in the case of a filter element for separating media, in particular for filtering fluids, such as, for example, hydraulic fluids, whereby the filter element can be accommodated in a filter housing with an inlet point for the medium to be filtered and an outlet point for the filtered medium, in that at least one data storage device is a component of the filter element such that by means of a reading device mounted on the exterior of the filter element, the data stored in the data storage device can be read out electronically from the data storage device.

In this case, the data storage device can be built into the filter element, for example poured or injected into a support tube, an end cap or an outer jacket of the filter element, or preferably can be permanently secured to the filter element from the outside, for example by bonding, welding, or the like. It may be advantageous if the data storage device cannot be detected from the outside. For some applications, it may be advantageous, however, if the site of the mounting of the data storage device on the filter element from the outside can be detected, for example by the data storage device itself being detectable or by a label being attached to the corresponding spot. The data storage device preferably does not project beyond the shape of the filter element. As a result, filter elements according to the invention can also be used in existing filter housings or in existing filter devices.

In a special embodiment, the data storage device is mounted close to or on an outside surface of the filter element, such that the data storage device also can be read in a state of the filter element that is closed to a filter device. As a result, it is not necessary to detach the filter element to read the data, but rather the data preferably can be read even in the operation of the filter device. In particular, in the case of elongated filter elements, it is advantageous if the data storage device is mounted close to or on a front side of the outside surface. This applies primarily in filter elements, in which the direction of flow of the medium to be filtered runs obliquely and especially crosswise to the longitudinal axis of the filter element. The distance between the data storage device and the reading device can thus be minimized, by which a more secure data transmission is possible even with low electrical output. For example, the data storage device can be mounted close to or on a connecting part of the filter element for connection to the filter device, or close to a sealable drain hole of the corresponding filter housing.

In particular, the data that specifies the filter element can be stored in the data storage device. In this case, for example, this can be data that make possible an identification only of the type of filter element, for example with respect to the filter material thereof, the media to be filtered, the dimensions, the manufacturing date, etc. In addition, data can be stored that make possible an identification of the individual filter element, for example a manufacturing number that is issued only once and preferably consecutively. If, in this case, these are data that are already specified in the production of the filter element, these data can be stored in a non-rewritable and read-only storage area of the data storage device, so that they are unchanging and in particular unmanipulable.

As an alternative or in addition, data can also be storable that occur only after the production of the filter element, in particular operating data of the filter element, such as the start-up date, the type and period of use, the filtered medium, etc. These data can be stored in a storage area of the data storage device that can be written to at least once, preferably in a storage area that can be written to only once, in which a continuous logging of the filter element can be filed. The data to be written can be provided with an unchanging date stamp. The writing of these data is preferably carried out via the reading device. When this storage area is writable only once, it is ensured that the operating data cannot be manipulated after the event. This is advantageous with respect to warranty claims, which could be filed in the event that a filter element fails. The feature that the data can be written only once in the data storage device can be effected by software engineering measures, for example by each memory address being usable only once for writing and then no longer being available, or by hardware engineering measures, for example by writing of irreversible memory processes being carried out, for example by fusing connecting leads.

In principle, the data transmission between the reading device and the data storage device can be carried out conventionally, in particular wired, for example via a defined or even standardized interface. In a special embodiment of the invention, the data transmission between the data storage device and the reading device is carried out wirelessly. In particular, the data can be read out from the data storage device wirelessly, for example by electromagnetic waves, and can be written to the data storage device wirelessly.

The data storage device preferably operates according to the transponder principle and is ready for data transmission only after a corresponding activation signal of the reading device, optionally secured by codewords. It is possible, for example, that the data from the data storage device can be read in that the data storage device or an associated receiver modifies—for example attenuates or, in a predetermined way, modulates—a signal that is transmitted by the reading device corresponding to the stored data, for example by altering the amplitude, phase or frequency of the electromagnetic field corresponding to the stored data. The reading device has a receiver that receives and optionally demodulates the modified signal and thus extracts the data from the data storage device.

In a special embodiment of the invention, the energy that is required for the operation of the data storage device can be transmitted from the reading device to the data storage device or to a receiver that is connected to a data storage device that is associated with the data storage device. The energy transfer preferably is carried out without contact, for example by intensive light irradiation, optionally in the infrared range, by provision of a sufficiently strong electromagnetic field or the like.

The data storage device is preferably designed as small semiconductor plates or chips and can have, for example, peripheral circuits for receiving and sending as well as for writing and reading out data. The data are preferably stored in digital form and are non-volatile, i.e., the data remain intact even after the energy supply is cut off. For some applications, it is advantageous if the sending element of the data storage device, for example a sending/receiving reel, is designed separately in the actual data storage device, for example the small semiconductor plates. In other applications, it is especially advantageous if this sending element is designed integrally with the data storage device, for example, the sending/receiving antenna is integrated with the small semi-conductor plates. This is especially advantageous in the case of data transmission by radiowaves with a frequency of above 100 MHz, preferably above 500 MHz, or even 1 GHz, since very small sizes thus are possible. The data are preferably stored digitally.

The invention also relates to a data transmission device for a filter device with a filter element according to the invention, the data transmission device having a reading device, which is a component of the filter device or can be secured to the filter device, such that data that are stored in a data storage device of the filter element can be read electronically by means of the reading device. To this end, the reading device is preferably mounted in close proximity to or on a connecting part of the filter device for the filter element. In the case of newly set-up filter devices, the reading device can also be integrated into the connecting part of the filter device. With existing filter devices, the reading device can be mounted on the filter device, for example it can be screwed into an existing coupling hole of the filter housing as a screw part or it can be combined with a contamination display unit that is already present on the filter device or integrated in the latter.

In particular for retrofitting existing filter devices, it is advantageous if the reading device can be secured to the filter device in a detachable manner by means of an attachment device. For example, the reading device can be secured with a type of clamp to the receiving flange of the filter device for the filter element.

In a special embodiment, [the data] can be written to the data storage device by a control device, which can be integrated into the reading device, continuously, at preset intervals and/or based on event-related parameters that pertain to the operation of the filter element in the filter device. In this case, they can be data that are determined locally on the site of the filter element, for example the differential pressure that occurs via the filter element, or they can be data that are specified by a higher-level control device that controls several reading devices, for example data for characterizing the medium to be filtered.

With use of the data that are read out from the data storage device, such as, for example, operating time, filtered medium, operating pressure, operating temperature, etc., a control device can calculate the remaining operating time or service life of the filter element. This calculation can be done in the reading device itself, or the reading device forwards these data to a higher-level control device, with which the data transmission device is connected by data-link. In particular in a corresponding way, this higher-level control device can monitor and control several filter elements that are retrofitted according to the invention, and, for example, when reaching a critical operating state, can control the filter device so that other filter elements are connected.

The data that are read out from the data storage device and/or the data that are calculated or derived therefrom can be signaled by a display device on the site of the filter element, for example by an illuminant for signaling an upcoming change-over of the filter element, by acoustic signal transmitters, or the like.

The energy for the operation of the data transmission device can be provided by electric feeders, whereby optionally a one-pole feeder is sufficient if the pipeline system of the filter device is used as an earth electrode. As a signal line, the one-pole feeder can also be used, for example by the signals being superposed as high-frequency signals of the energy supply line.

It is especially advantageous if the energy is obtained locally on the site of the filter element, for example from the energy of the flowing medium, from a difference of the electrochemical potential of the medium and its surrounding area by a galvanic element and/or from a temperature difference between the medium and its surrounding area with use of the SEEBECK Effect. In this case, it may be advantageous if the data transmission device also has an energy reservoir, for example a conventional accumulator or a capacitive energy reservoir.

Further advantages, features and details of the invention will be apparent from the dependent claims and the following description, in which several embodiments are described in detail with reference to the drawings. The individual features that are mentioned in the claims and in the description can be essential for the invention individually or in any combination.

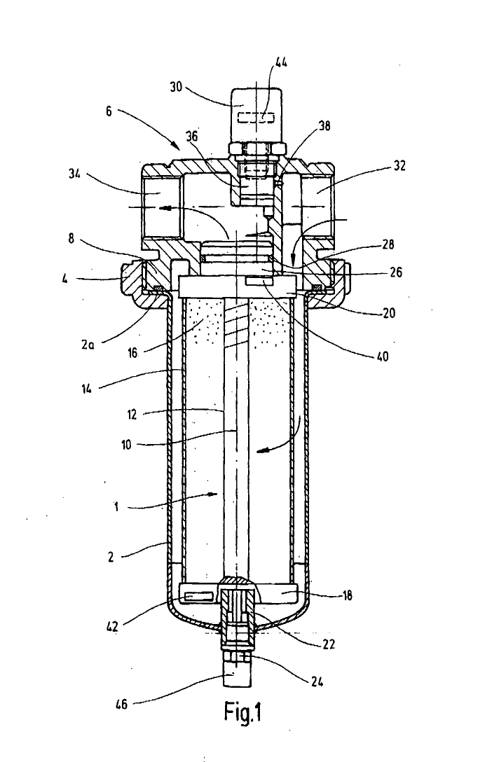

FIG. 1 shows a filter element according to the invention, and

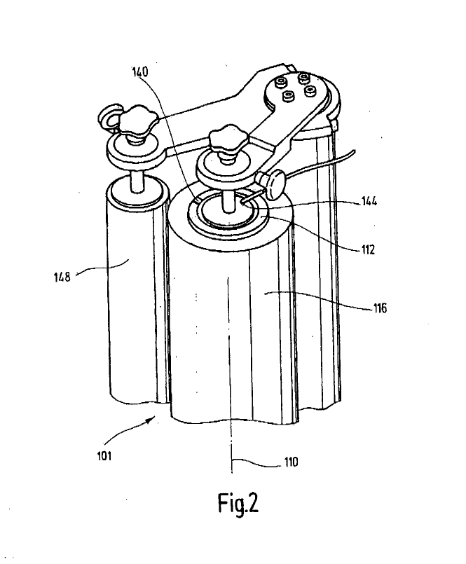

FIG. 2 shows a second embodiment of a filter element according to the invention.

FIG. 1 shows, partially in cross-section, a filter element I for separating media according to the invention, in particular as it is used as an in-line filter for filtering hydraulic fluids. The filter element 1 can be accommodated in a cup-shaped filter housing 2, which is essentially hollow-cylindrical and forms an outside flange 2a on its free end, with which the filter housing 2 is secured in a detachable manner by means of a box nut 4 to an adapter 8 that preferably is designed integrally by a filter head 6 and that has an outside thread.

The filter element 1 is essentially cylindrical, in particular circular-cylindrical, with a longitudinal axis 10. The filter element 1 has a support tube 12 that is configured concentrically to the longitudinal axis 10 and that has openings for the medium on its outside surface, on which said support tube, for example, a flat, pleated filter material 16 is wound. In particular, if a rewinding option is desired, the filter element 1 can also have a support jacket 14.

On its front sides, the filter element 1 in each case has an end cap 18, 20, whereby a first end cap 20 preferably integrally forms an adapter 26, which has an annular groove on the outside, in which a sealing element 28 can be inserted. The adapter 26 can be inserted into a corresponding opening in the filter head 6 and connected tightly with the filter head 6. On the one hand, the filter head 6 is a component of the filter housing 2 and at the same time part of a filter device that is not further shown in FIG. 1 and that may have several filter elements, accumulators, line systems and the like.

On its side opposite to the opening for accommodating the filter element 1, the filter head 6 has a threaded hole 36, into which essentially a blind plug can also be screwed. In the embodiment that is shown, a display device 30, which also measures the pressure between the inlet point 32 and the outlet point 34, is screwed into the threaded hole 36. For this purpose, the threaded hole 36 projects into the outlet chamber of the filter head 6 that is connected to the outlet point 34 and in addition has a connecting channel 38 in the inlet chamber of the filter head 6 that is connected to the inlet point 32. As a result, a differential pressure measurement between the inlet point 32 and the outlet point 34 is possible, which also gives indications on the condition of the filter element 1 and its remaining service life.

When the filter element 1 is mounted, a second end cap 18 is configured close to the closed side of the filter housing 2 can be mounted in particular by means of a recess inserted preferably centrically into the second end cap 18 on an outlet connector 22 that is formed by the filter housing 2 and into which an outlet screw 24 can be screwed, by means of which the outlet opening of the filter housing 2 can be closed.

A data storage device 40, 42 is integrated into at least one of the end caps 18, 20, preferably so that the data storage device 40, 42 is not visible from the outside. A first data storage device 40 is preferably configured on the first end cap 20, preferably eccentrically relative to the longitudinal axis 10 in the area of the front circular ring surface that extends around the adapters 26. A reading device 44 for the first data storage device 40 is integrated in the display device 30. A short transmission path between the reading device 44 and the first data storage device 40 is ensured by this configuration, so that a reliable data transmission is possible with low electrical power.

If necessary, an energy supply line and/or a signal line can be brought into the display device 30, which is not shown in FIG. 1 for the sake of clarity. In the display device 30, a local control unit, which controls the displays of a filter change based on data read out from the first data storage device 40 in connection with the measured differential pressure between the inlet point 32 and the outlet point 36, can also be mounted. The control unit can calculate and display in particular the degree of contamination and/or the remaining service life of the filter element 1. This indication can be done optically, for example by a display, by light diodes, signal lamps or the like, and/or by acoustic signal transmitters.

As an alternative or in addition, an additional reading device 46 can also be mounted in the area of the outlet connector 22, preferably in the area of the outlet screw 24 or designed integrally with the latter; by means of which reading device a second data storage device 42 can be read. Also, the additional reading device 46 that is mounted in this area can be connected via energy supply lines and/or control lines to a higher-level control device. This higher-level control device can first examine, for example by querying the data storage device 40, 42, whether a filter element 1 that is suitable for the given application is inserted into the filter housing 2, and, moreover, it can also read the previous operating data from the data storage device 40, 42 and calculate therefrom the remaining operating time of the filter element, and connect the filter element 1 to the filter circuit or activate the filter device only when the corresponding data are present.

Even during operation, the higher-level control device can continuously query, at regular or irregular intervals or in response to events, the status of the filter element 1 by reading the data storage device 40, 42. In a corresponding way, data can also be written to the data storage device 40, 42 via the reading device 44, 46 in order to store, for example, operating parameters, to which the filter element 1 was exposed in the previous operation.

In addition, it is possible that via the reading device 44, 46, it is examined whether the filter element 1 that was used corresponds to the specifications that are required for the respective application. For example, an identification number of the filter element 1 that is stipulated by the higher-level control device can be queried. The data that are read out from the data storage device 40, 42 can then be examined in particular as to whether it is a filter element 1 of the stipulated type, for example a filter element of the original manufacturer, whether the filter element 1 has the fineness that is necessary for the filtration of the medium, whether the remaining service life is still adequate, etc. In particular if the calculation of the remaining service life is based on the evaluation of the measured differential pressure between the inlet point 32 and the outlet point 34, an increase in the accuracy can be achieved by the filter element 1 according to the invention, since the specific type of the filter element 1 can be determined and can be taken into consideration in the calculation of the remaining service life. Thus, a specific calculation, for example based on a furnished curve or table for the connection between measured differential pressure and remaining service life, can be carried out, whereby this connection may be greatly different from filter type to filter type.

The data can be stored encoded in the data storage device 40, 42 to prevent manipulations. The data storage device 40, 42 is configured as a transponder, so that it is activated only upon the corresponding activation signal by the reading device 44, 46. In the simplest case, an electromagnetic signal that is transmitted from the reading device 44, 46 is altered in its amplitude, frequency and/or phase by the data storage device 40, 42, and this alteration is recorded by the reading device 44, 46 and optionally also evaluated. For complex applications, an electric circuit in the data storage device 40, 42 can be activated by the transmitting signal of the reading device 44, 46, and digital data can be actively transmitted back from the data storage device 40, 42, in particular from a transmitting unit that is mounted in the data storage device 40, 42, to the reading device 44, 46.

In particular, if, as in the embodiment shown, the reading devices 44, 46 are mounted directly in the area of the flow of fluid, an energy supply of a data transmission device that has the reading device 44, 46 also can be carried out by using physical or chemical effects, for example by the difference of the electrochemical potentials of the medium to be filtered and the surrounding atmosphere or a material of the filter housing being used for energy recovery, or a temperature difference between the filter element—in particular the medium to be filtered—and the environment that occurs in operation in any event.

FIG. 2 shows a second embodiment of a filter element 101 according to the invention. In this case, this is an above-mentioned band-pass filter, in FIG. 2, only its upper partial area being shown, which is used in an associated band-pass filter device with a filter housing that is not shown. Such a band-pass filter device is known from, for example, DE 101 26 443 A1.

The filter element 101 has a support tube 112 as a winding form, onto which, as filter material 116, a filter strip is wound with, for example, 100 turns, in particular a filter fleece, for example a glass/polyester fleece or a paper fleece. The support tube 112 bounds an inside filter cavity, in which the filtered medium enters through openings in the support tube 112, after it has flowed through the filter material 116 from the outside to the inside. In the operation, the filter strip is unwound, if necessary, from the support tube 112 and is wound on a driven winding roller 148.

On its front end, the data storage device 140 is secured on the support tube 112, and said data storage device can be read by means of the reading device 144. At the same time, the rotation of the support tube 112 when the filter material 116 is unwound can be detected by the reading device 144. For this purpose, above the support tube 112, the reading device 144 is mounted on a holding device, eccentrically relative to the longitudinal axis 110 of the filter element 101, which simultaneously forms the axis of rotation. During the course of the rotation, the signal coupling between the reading device 144 and the data storage device 140 is greatly different based on the angle position of the data storage device 140 relative to the longitudinal axis 110.

The corresponding signal routing can be evaluated to the extent that the reading device 144 determines the number of rotations and thus can calculate the remaining filter capacity. In this calculation, not only the determination of the still available length of the unused band-pass filter, but also the determination of the previous use of filter material based on the operating condition are carried out. By the configuration of the filter element 101 according to the invention with a data storage device 140, a separate sensor element for determining the still remaining filter length may therefore be omitted.

1. Filter element (1) for separating media, in particular for filtering fluids, such as, for example, hydraulic fluids, whereby the filter element can be accommodated in a filter housing (2) with an inlet point (32) for the medium to be filtered and an outlet point (34) for the filtered medium, characterized in that at least one data storage device (40, 42) is a component of the filter element (1), such that by means of a reading device (44, 46) that is mounted outside of the filter element, the data from the data storage device (40, 42) that are stored in the data storage device (40, 42) can be read electronically.

2. The filter element (1) according to claim 1, wherein the data storage device (40, 42) is mounted close to or on an outside surface of the filter element (1), in particular close to or on a front outside surface of an elongated filter element (1), such that the data storage device (40, 42) can also be read in a condition of the filter element (1) that is connected to a filter device.

3. The filter element (1) according to claim 1, wherein data are stored in a non-rewritable and read-only memory area of the data storage device (40, 42), which make possible an identification of a type of filter element (1), preferably even an identification of the individual filter element (1).

4. The filter element (1) according to claim 1, wherein data, in particular operating data of the filter element (1), can be stored in a memory area of the data storage device (40, 42) that can be written to at least once.

5. The filter element (1) according to claim 1, wherein the data transmission between the data storage device (40, 42) and the reading device (44, 46) is carried out wirelessly; in particular the data can be read out from the data storage device (40, 42) wirelessly and/or can be written to the data storage device (40, 42) wirelessly.

6. The filter element (1) according to claim 1, wherein the data storage device (40, 42) operates according to the transponder principle, and data from the data storage device (40, 42) can be read after suitable stimulation of the reading device (44, 46) or data can be written to the data storage device (40, 42).

7. Filter element (1) according to claim 1, wherein the energy that is necessary for the operation of the data storage device (40, 42) can be transmitted from the reading device (44, 46) to the data storage device (40, 42) or to a receiver that is associated with the data storage device (40, 42) and connected to the data storage device (40, 42).

8. Data transmission device for a filter device with at least one filter element (1) for separating media, in particular for filtering fluids, such as, for example, hydraulic fluids, whereby the filter element (1) can be accommodated in a filter housing (2) with an inlet point (32) for the medium to be filtered and an outlet point (34) for the filtered medium, wherein the data transmission device has a reading device (44, 46) that is a component of the filter device or can be secured to the filter device, such that data that is stored in a data storage device (40, 42) of the filter element (1) can be electronically read out by means of the reading device (44, 46).

9. The data transmission device according to claim 8, wherein the reading device (44, 46) is mounted or can be secured close to or on a connecting part of the filter device for the filter element (1).

10. The data transmission device according to claim 8, wherein the reading device (44, 46) can be secured in a detachable manner to the filter device by means of an attachment device.

11. The data transmission device according to claim 8, wherein [the data] can be written to the data storage device (40, 42) of the filter element (1) by a control device that is controlled continuously by the reading device (44, 46) at preset intervals or based on event-related parameters that pertain to the operation of the filter element (1) in the filter device.

12. The data transmission device according to claim 8, wherein by using data that are read out from the data storage device (40, 42) by a control device, the remaining operating time of the filter element (1) can be calculated.

13. The data transmission device according to claim 8, wherein the data transmission device is connected by data-link to a higher-level control device.

14. The data transmission device according to claim 8 3, wherein the data transmission device has a display device (30), by means of which the data that are read out from the data storage device (40, 42) and/or data that are derived therefrom can be signaled.

15. The data transmission device according to claim 8, wherein the energy for the operation of the data transmission device is obtained from the energy of the flowing medium, from a difference of the electrochemical potentials of the medium and its surrounding area and/or from a temperature difference between the medium and its surrounding area.
